(19) United States
(12) Patent Application Publication
(10) Pub. No.: US 2025/0031001 A1
(43) Pub. Date: Jan. 23, 2025

(54) ACOUSTIC REPRODUCTION METHOD, RECORDING MEDIUM, AND ACOUSTIC REPRODUCTION DEVICE

(71) Applicant: Panasonic Intellectual Property Corporation of America, Torrance, CA (US)

(72) Inventors: Hikaru USAMI, Osaka (JP); Tomokazu ISHIKAWA, Osaka (JP); Seigo ENOMOTO, Kyoto (JP); Mariko YAMADA, Hyogo (JP); Kota NAKAHASHI, Osaka (JP)

(21) Appl. No.: 18/906,434

(22) Filed: Oct. 4, 2024

Related U.S. Application Data
(63) Continuation of application No. PCT/JP2023/012612, filed on Mar. 28, 2023.
(60) Provisional application No. 63/330,848, filed on Apr. 14, 2022.

(30) Foreign Application Priority Data
Feb. 2, 2023 (JP) 2023-014559

(51) Int. Cl. H04S 7/00

(52) U.S. Cl. CPC H04S 7/301; H04S 2400/09; H04S 2400/15

(57) ABSTRACT

An acoustic reproduction method includes: obtaining a sound signal indicating a sound that reaches a listener in a sound reproduction space and processing information indicating whether to perform, on the sound signal, reduction processing for reducing noise included in the sound; determining processing content of the reduction processing when the processing information obtained indicates that the reduction processing is to be performed; performing the reduction processing, based on the processing content determined; and outputting the sound signal on which the reduction processing has been performed.

### CROSS REFERENCE TO RELATED APPLICATIONS

This is a continuation application of PCT International Application No. PCT/JP2023/012612 filed on Mar. 28, 2023, designating the United States of America, which is based on and claims priority of U.S. Provisional Patent Application No. 63/330,848 filed on Apr. 14, 2022 and Japanese Patent Application No. 2023-014559 filed on Feb. 2, 2023. The entire disclosures of the above-identified applications, including the specifications, drawings and claims are incorporated herein by reference in their entirety.

### FIELD

The present disclosure relates to an acoustic reproduction method and others.

### BACKGROUND

Patent Literature (PTL) 1 discloses an acoustic reproduction device that can output a sound that provides realistic sensations by obtaining a sound signal and generating reverberation for the sound signal.

### CITATION LIST

### Patent Literature

PTL 1: International Publication No. WO2006/92995

### SUMMARY

### Technical Problem

There has been a demand for outputting a sound that provides further realistic sensations.

In view of this, the present disclosure is to provide, for instance, an acoustic reproduction method with which a sound that provides further realistic sensations can be output.

### Solution to Problem

An acoustic reproduction method according to an aspect of the present disclosure includes: obtaining a sound signal and processing information, the sound signal indicating a sound that reaches a listener in a sound reproduction space, the processing information indicating whether to perform, on the sound signal, reduction processing for reducing noise included in the sound; determining processing content of the reduction processing when the processing information obtained indicates that the reduction processing is to be performed; performing the reduction processing, based on the processing content determined; and outputting the sound signal on which the reduction processing has been performed.

A recording medium according to an aspect of the present disclosure is a non-transitory computer-readable recording medium having recorded thereon a computer program for causing a computer to execute the acoustic reproduction method stated above.

An acoustic reproduction device according to an aspect of the present disclosure includes: an obtainer that obtains a sound signal and processing information, the sound signal indicating a sound that reaches a listener in a sound reproduction space, the processing information indicating whether to perform, on the sound signal, reduction processing for reducing noise included in the sound; a processing determiner that determines processing content of the reduction processing when the processing information obtained indicates that the reduction processing is to be performed; a reduction processor that performs the reduction processing, based on the processing content determined; and an outputter that outputs the sound signal on which the reduction processing has been performed.

Note that these general or specific aspects may be implemented using a system, a device, a method, an integrated circuit, a computer program, or a non-transitory computer-readable recording medium such as a compact disc read-only memory (CD-ROM), or any combination of systems, devices, methods, integrated circuits, computer programs, or recording media.

### Advantageous Effects

According to an acoustic reproduction method according to an aspect of the present disclosure, a sound that provides further realistic sensations can be output.

### BRIEF DESCRIPTION OF DRAWINGS

These and other advantages and features will become apparent from the following description thereof taken in conjunction with the accompanying Drawings, by way of non-limiting examples of embodiments disclosed herein.

FIG. 1 is a block diagram illustrating a functional configuration of an acoustic reproduction device according to Embodiment 1.

FIG. 2 is a flowchart illustrating Operation Example 1 of the acoustic reproduction device according to Embodiment 1.

FIG. 3 illustrates a relation between time and amplitude of a sound signal on which reduction processing has been performed according to Embodiment 1.

FIG. 4 illustrates a power spectrum of the sound signal illustrated in FIG. 3.

FIG. 5 illustrates a relation between time and amplitude of a synthesized sound signal according to Embodiment 1.

FIG. 6 illustrates a power spectrum of the synthesized sound signal illustrated in FIG. 5.

FIG. 7 is a flowchart illustrating Operation Example 2 of the acoustic reproduction device according to Embodiment 1.

FIG. 8 illustrates two sound reproduction spaces and the positions of two sound sources according to Embodiment 1.

FIG. 9 illustrates the two sound reproduction spaces and the positions of the two sound sources according to Embodiment 1.

FIG. 10 is a block diagram illustrating a functional configuration of an acoustic reproduction device according to Embodiment 2.

FIG. 11 is a flowchart illustrating Operation Example 3 of the acoustic reproduction device according to Embodiment 2.

FIG. 12 illustrates a threshold and a noise floor level according to Embodiment 2.

### DESCRIPTION OF EMBODIMENTS

### (Underlying Knowledge Forming Basis of the Present Disclosure)

Conventionally, an acoustic reproduction method for outputting a sound that provides realistic sensations has been known.

For example, PTL 1 discloses an acoustic reproduction device as an example of acoustic reproduction technology with which a sound that provides realistic sensations can be output by obtaining a sound signal and generating reverberation for the sound signal.

A sound indicated by a sound signal obtained by the acoustic reproduction device disclosed in PTL 1 may include a target sound for a listener to hear and noise other than the target sound. In this case, the acoustic reproduction device disclosed in PTL 1 generates a reverberation signal that indicates reverberation, based on a sound signal indicating a sound that includes the noise, and outputs, to a listener, a sound signal (a synthesized sound signal) resulting from synthesizing the sound signal and the generated reverberation signal. The synthesized sound signal indicates a sound resulting from synthesizing reverberation and a sound that includes noise, so that the listener is to hear a sound resulting from synthesizing the reverberation and the sound that includes noise.

As described above, a reverberation signal is generated based on a sound signal indicating a sound that includes noise, and more specifically, reverberation indicated by a reverberation signal is generated based on a sound that includes noise. Accordingly, when the listener hears such reverberation, the listener may feel odd so that the listener cannot hear a sound that provides sufficient realistic sensations. Thus, with the acoustic reproduction technology disclosed by PTL 1, it is difficult to output a sound that provides sufficient realistic sensations when a sound indicated by an obtained sound signal includes noise. Consequently, there has been a demand for an acoustic reproduction method and others with which a sound that provides further realistic sensations can be output.

In view of this, an acoustic reproduction method according to a first aspect of the present disclosure includes: obtaining a sound signal and processing information, the sound signal indicating a sound that reaches a listener in a sound reproduction space, the processing information indicating whether to perform, on the sound signal, reduction processing for reducing noise included in the sound; determining processing content of the reduction processing when the processing information obtained indicates that the reduction processing is to be performed; performing the reduction processing, based on the processing content determined; and outputting the sound signal on which the reduction processing has been performed.

Accordingly, processing information is obtained in the obtaining, and thus noise included in a sound indicated by a sound signal is reduced in the performing, according to whether to perform reduction processing for reducing noise, which is indicated by the processing information. For example, a reverberation signal indicating reverberation may be generated based on the sound signal on which such processing has been performed, and a synthesized sound signal resulting from synthesizing the sound signal and the reverberation signal (a synthesized sound signal) may be output to a listener. In this case, reverberation that the listener hears is a sound based on a sound with reduced noise. The listener is less likely to feel odd even when he/she hears such reverberation and thus can hear a sound that provides realistic sensations. Hence, an acoustic reproduction method can be realized with which a sound that provides further realistic sensations can be output in such a case, even when a sound indicated by the obtained sound signal includes noise.

For example, an acoustic reproduction method according to a second aspect of the present disclosure is the method according to the first aspect in which in the obtaining, space information and position information are obtained, the space information indicating a shape and an acoustic property of the sound reproduction space, the position information indicating a position of the listener in the sound reproduction space, and in the performing, whether to perform the reduction processing is determined based on the space information obtained and the position information obtained.

Accordingly, whether to perform the reduction processing is determined according to the shape and an acoustic property of the sound reproduction space in which the listener is present. For example, when the reduction processing is not performed, a processing load of the acoustic reproduction method can be reduced.

For example, an acoustic reproduction method according to a third aspect of the present disclosure is the method according to the second aspect in which in the performing, the reduction processing is determined not to be performed when the position of the listener is included in the sound reproduction space in which no reverberation occurs.

Accordingly, when the position of the listener is included in a sound reproduction space in which reverberation is not generated, the reduction processing is not performed, and thus a processing load of the acoustic reproduction method can be reduced.

For example, an acoustic reproduction method according to a fourth aspect of the present disclosure is the method according to any one of the first to third aspects in which in the obtaining, processing content information indicating the processing content is obtained, and in the performing, the processing content indicated by the processing content information obtained is performed.

Accordingly, the reduction processing can be performed according to the processing content indicated by the processing content information.

For example, an acoustic reproduction method according to a fifth aspect of the present disclosure is the method according to the second or third aspect further including: generating a reverberation signal indicating reverberation, based on the sound signal on which the reduction processing has been performed and the space information obtained, and in the method, in the outputting, a synthesized sound signal is output, the synthesized sound signal resulting from synthesizing the sound signal on which the reduction processing has been performed and the reverberation signal generated.

Accordingly, a reverberation signal indicating reverberation occurs based on a sound signal indicating a sound with reduced noise. Thus, reverberation that the listener hears is a sound based on the sound with reduced noise. The listener is less likely to feel odd even when he/she hears such reverberation, and thus can hear a sound that provides realistic sensations. Hence, an acoustic reproduction method with which a sound that provides further realistic sensations can be output, even when a sound indicated by the obtained sound signal includes noise.

For example, an acoustic reproduction method according to a sixth aspect of the present disclosure is the method according to the fifth aspect in which in the obtaining, threshold data indicating a threshold is obtained, the acoustic reproduction method further includes: comparing a noise floor level with the threshold indicated by the threshold data obtained, the noise floor level being in a predetermined frequency range in a power spectrum representing the synthesized sound signal, and in the determining, the processing content of the reduction processing is updated based on a comparison result obtained in the comparing.

In this manner, the processing content of the reduction processing is updated based the result of the comparison between the threshold and the noise floor level, and thus a sound that provides more realistic sensations can be output with the acoustic reproduction method.

For example, an acoustic reproduction method according to a seventh aspect of the present disclosure is the method according to the sixth aspect in which the threshold is a target value of the noise floor level, and in the determining, the processing content is updated to cause the reduction processing to be processing for reducing the noise to a greater extent when the noise floor level is higher than the threshold.

Accordingly, when the noise floor level is higher than the threshold, noise can be reduced to a greater extent, and thus a sound that provides further realistic sensations can be output with the acoustic reproduction method.

A recording medium according to an eighth aspect of the present disclosure is a non-transitory computer-readable recording medium having recorded thereon a computer program for causing a computer to execute an acoustic reproduction method according to any one of the first to seventh aspects.

Accordingly, the computer can execute the above acoustic reproduction method according to the program.

An acoustic reproduction device according to a ninth aspect of the present disclosure includes: an obtainer that obtains a sound signal and processing information, the sound signal indicating a sound that reaches a listener in a sound reproduction space, the processing information indicating whether to perform, on the sound signal, reduction processing for reducing noise included in the sound; a processing determiner that determines processing content of the reduction processing when the processing information obtained indicates that the reduction processing is to be performed; a reduction processor that performs the reduction processing, based on the processing content determined; and an outputter that outputs the sound signal on which the reduction processing has been performed.

Accordingly, the obtainer obtains processing information, and thus the reduction processor reduces noise included in a sound indicated by a sound signal, according to whether to perform reduction processing for reducing noise, which is indicated by the processing information. For example, a reverberation signal indicating reverberation may be generated based on the sound signal on which such processing has been performed, and a synthesized sound signal resulting from synthesizing the sound signal and the reverberation signal (a synthesized sound signal) may be output to a listener. In this case, reverberation that the listener hears is a sound based on a sound with reduced noise. The listener is less likely to feel odd even when he/she hears such reverberation, and can listen to a sound that provides realistic sensations. Thus, an acoustic reproduction device can be realized which can output a sound that provides further realistic sensations in such a case, even when a sound indicated by the obtained sound signal includes noise.

Furthermore, these general or specific aspects may be implemented using a system, a device, a method, an integrated circuit, a computer program, or a non-transitory computer-readable recording medium such as a CD-ROM, or any combination of systems, devices, methods, integrated circuits, computer programs, or recording media.

In the following, embodiments are to be specifically described with reference to the drawings.

Note that the embodiments described below each show a general or specific example. The numerical values, shapes, materials, elements, the arrangement and connection of the elements, steps, and the processing order of the steps, for instance, described in the following embodiments are mere examples, and thus are not intended to limit the scope of the claims.

In the following description, ordinal numbers such as first and second may be given to elements. These ordinal numbers are given to elements in order to distinguish between the elements, and thus do not necessarily correspond to an order that has intended meaning. Such ordinal numbers may be switched as appropriate, new ordinal numbers may be given, or the ordinal numbers may be removed.

The drawings are schematic diagrams, and do not necessarily provide strictly accurate illustration. Accordingly, scaling is not necessarily consistent throughout the drawings. In the drawings, the same numeral is given to substantially the same configuration, and a redundant description thereof may be omitted or simplified.

In this Specification, a numerical range is not an expression that has only a strict meaning, but is an expression that also covers a substantially equivalent range that includes a difference of about several percent, for example.

### Embodiment 1

### [Configuration]

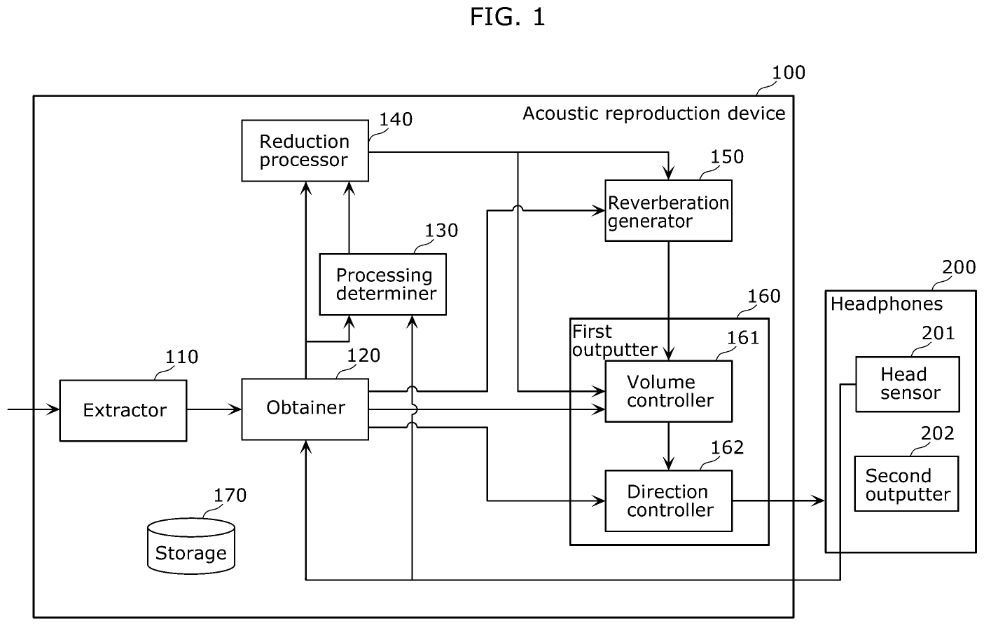

First, a configuration of acoustic reproduction device 100 according to Embodiment 1 is to be described. FIG. 1 is a block diagram illustrating a functional configuration of acoustic reproduction device 100 according to the present embodiment.

Acoustic reproduction device 100 according to the present embodiment is a device for a listener to hear a sound, by performing processing on a sound signal that indicates a sound that reaches the listener in a sound reproduction space and outputting the resultant sound signal to headphones 200 that the listener is wearing. More specifically, acoustic reproduction device 100 is a stereophonic sound reproduction device for a listener to hear a stereophonic sound.

Acoustic reproduction device 100 according to the present embodiment is applicable to various applications such as virtual reality (VR) and augmented reality (AR), as examples. Note that in the present embodiment, a sound reproduction space means a virtual reality space or an augmented reality space for use in various applications such as virtual reality and augmented reality.

Next, headphones 200 are to be described.

As illustrated in FIG. 1, headphones 200 are a second output device that includes head sensor 201 and second outputter 202.

Head sensor 201 senses a direction in which the head of a listener is directed and the position of the listener determined by coordinates on a horizontal plane and the height in the vertical direction, and outputs, to acoustic reproduction device 100, detection information indicating the direction in which the head of the listener is directed and the position of the listener determined by the coordinates on the horizontal plane and the height in the vertical direction. Note that the direction in which the head of a listener is directed is also a direction in which the face of the listener is directed.

Head sensor 201 may sense information of six degrees of freedom (6DoF) of the head of a listener. For example, head sensor 201 may be an inertial measurement unit (IMU), an accelerometer, a gyroscope, or a magnetic sensor, or a combination of these.

Detection information includes a rotation amount or a displacement amount, for instance, sensed by head sensor 201.

In the following, the direction in which the head of a listener is directed may be referred to as the direction of a listener in order to simplify the description.

Second outputter 202 is a device that reproduces a sound that reaches a listener in a sound reproduction space. More specifically, second outputter 202 reproduces the sound based on a sound signal indicating the sound processed by acoustic reproduction device 100 and output from acoustic reproduction device 100.

Next, acoustic reproduction device 100 illustrated in FIG. 1 is to be described.

As illustrated in FIG. 1, acoustic reproduction device 100 includes extractor 110, obtainer 120, processing determiner 130, reduction processor 140, reverberation generator 150, first outputter 160, and storage 170.

Extractor 110 obtains audio content information, and extracts predetermined information and a signal that are included in the obtained audio content information. Extractor 110 obtains audio content information from a storage device (not illustrated) provided outside of acoustic reproduction device 100, for example. Note that extractor 110 may obtain audio content information stored in storage 170 included in acoustic reproduction device 100.

Extractor 110 extracts a sound signal, processing information, space information, position information, and processing content information from the obtained audio content information.

A sound signal indicates a sound that reaches a listener in a sound reproduction space. A sound that reaches the listener includes a target sound for the listener to hear and noise other than the target sound, and more specifically, is constituted by a target sound and noise. A target sound is a sound uttered from a person or a music, for example, and noise is ambient noise that is unintentionally mixed when the target sound is collected or is reverberation according to a sound collecting environment. A sound signal indicates a sound that reaches a listener, and is digital data represented in a format such as WAVE, MP3, or WMA.

The processing information indicates whether to perform, on such a sound signal as above, reduction processing for reducing noise included in a sound that reaches a listener. The processing information indicates that reduction processing is to be performed or is not to be performed. For example, when the processing information indicates that reduction processing is to be performed, “1” is indicated as a flag, whereas when the processing information indicates that reduction processing is not to be performed, “0” is indicated as a flag.

The space information indicates the shape and an acoustic property of a sound reproduction space. The sound reproduction space indicated by the space information may be a space in which a listener is present or a space in which no listener is present in an application such as virtual reality or augmented reality. The space information indicates the shape of the sound reproduction space, and more specifically, indicates provided positions and shapes of objects provided in the sound reproduction space (such as a wall, a door, a floor, a ceiling, and furniture). The space information indicates an acoustic property showing which frequency of a sound is reflected or absorbed to what degree when the provided objects reflect or absorb the sound. The space information further indicates a position of a sound source provided in the sound reproduction space. The sound source emits a sound that reaches a listener in the sound reproduction space.

The position information indicates the position of a listener in a sound reproduction space. More specifically, when a plurality of sound reproduction spaces are provided, position information indicates a sound reproduction space in which a listener is present among the sound reproduction spaces, and indicates the position at which the listener is present within the sound reproduction space in which the listener is present.

The processing content information indicates processing content of reduction processing for reducing noise included in a sound that reaches a listener when the obtained processing information indicates that the reduction processing is to be performed. For the noise reduction processing, sound enhancement, for example, may be used, but the method used therefor is not limited thereto, and a known method may be used. The processing content information indicates that a method used for the noise reduction processing is sound enhancement and indicates information for using the sound enhancement. The processing content information may include information indicating which method is to be used among a plurality of methods for the noise reduction processing.

In this manner, in the present embodiment, audio content information includes a sound signal, processing information, space information, position information, and processing content information.

The audio content information may be subjected to encoding processing such as MPEG-H 3D Audio (ISO/IEC 23008-3) (hereinafter, referred to as MPEG-H 3D Audio). Thus, extractor 110 obtains audio content information that is an encoded bit stream. Extractor 110 obtains and decodes audio content information. Extractor 110 performs decode processing based on, for instance, MPEG-H 3D Audio stated above. Hence, extractor 110 functions as a decoder, for example. Extractor 110 decodes encoded audio content information, and provides obtainer 120 with a sound signal, processing information, space information, position information, and processing content information that result from the decoding.

Obtainer 120 obtains the sound signal, the processing information, the space information, the position information, and the processing content information extracted by extractor 110. Obtainer 120 provides each of processing determiner 130, reduction processor 140, reverberation generator 150, and first outputter 160 with the obtained signal and the obtained information items. Here, rather than providing each of processing elements such as processing determiner 130, reduction processor 140, reverberation generator 150, and first outputter 160 with the signal and the information items, obtainer 120 may provide each of the processing elements with one or more of the signal and the information items to be used by the processing element. Note that in the present embodiment, extractor 110 extracts a sound signal and others from audio content information and obtainer 120 obtains the extracted sound signal, processing information, space information, position information, and processing content information, but the present embodiment is not limited thereto. For example, obtainer 120 may obtain a sound signal, processing information, space information, position information, and processing content information from a storage device (not illustrated) provided outside of acoustic reproduction device 100 or storage 170, for example. Obtainer 120 further obtains detection information that includes a rotation amount or a displacement amount detected by headphones 200 (head sensor 201, more specifically) and the position and the direction of the listener. Obtainer 120 determines the position and the direction of the listener in a sound reproduction space, based on the obtained detection information. Thus, here, obtainer 120 determines the position and the direction of the listener indicated by the obtained detection information to be the position and the direction of the listener in a sound reproduction space. The position of the listener may be represented by coordinates on the horizontal plane and the height in the vertical direction. Obtainer 120 updates position information according to the position and the direction of the listener that are determined. Thus, the position information that obtainer 120 gives to the processing elements is information that includes updated position information.

Processing determiner 130 determines processing content of the reduction processing when the processing information obtained by obtainer 120 indicates that the reduction processing is to be performed. More specifically, processing determiner 130 determines processing content indicated by the processing content information obtained by obtainer 120 is processing content of the reduction processing when the processing information indicates that the reduction processing is to be performed.

Reduction processor 140 performs, on a sound signal indicating a sound that reaches a listener, reduction processing for reducing noise included in the sound, based on the processing content determined by processing determiner 130. A sound signal on which the reduction processing has been performed is a signal indicating a sound with reduced noise. Note that when processing information obtained by obtainer 120 indicates that the reduction processing is not to be performed, processing determiner 130 does not determine processing content of the reduction processing, and reduction processor 140 does not perform the reduction processing.

Reverberation generator 150 generates a reverberation signal indicating reverberation, based on a sound signal on which reduction processor 140 has performed the reduction processing and space information obtained by obtainer 120. Reverberation generator 150 may generate reverberation by applying a known reverberation generation method to the sound signal. An example of the known reverberation generation method is the Schroeder method, but the method is not limited thereto. Reverberation generator 150 uses the shape and an acoustic property of a sound reproduction space indicated by the space information when the known reverberation generation method is applied. Accordingly, reverberation generator 150 can generate a reverberation signal that indicates reverberation.

In the present embodiment, a reverberation signal generated by reverberation generator 150 indicates reverberation based on a sound with reduced noise, or stated differently, reverberation that a listener hears is a sound based on a sound with reduced noise. Note that reverberation herein is late reverberation, but may include initial reflection and late reverberation. Furthermore, reverberation generator 150 may generate virtual acoustic effects other than late reverberation by performing acoustic processing on a sound signal using space information. For example, at least one of acoustic effects such as diffracted sound generation, a range attenuation effect, localization, sound image processing, and the Doppler effect is considered to be added. Obtainer 120 may obtain information for switching between on and off of all or one or more of the acoustic effects, together with the space information.

First outputter 160 is an example of an outputter, and outputs a sound signal on which reduction processor 140 has performed reduction processing. More specifically, first outputter 160 outputs, to headphones 200, a synthesized sound signal resulting from synthesizing a sound signal on which reduction processor 140 has performed reduction processing and a reverberation signal generated by reverberation generator 150. A synthesized sound signal indicates a synthesized sound, and a synthesized sound includes a sound with reduced noise and reverberation based on the sound with reduced noise. Here, first outputter 160 includes volume controller 161 and direction controller 162.

Volume controller 161 determines the volume of a sound with reduced noise indicated by a sound signal on which reduction processor 140 has performed reduction processing, and the volume of reverberation indicated by a reverberation signal generated by reverberation generator 150. Volume controller 161 may determine the volume of a sound with reduced noise and the volume of reverberation, based on volume information. The volume information indicates a ratio of the volume of a sound with reduced noise indicated by a sound signal on which reduction processing has been performed to the volume of reverberation indicated by a reverberation signal. Volume controller 161 determines the volume of a sound with reduced noise and the volume of reverberation to cause a ratio of a sound with reduced noise output by first outputter 160 to the volume of reverberation output thereby to be the ratio indicated by the volume information.

Note that the volume information may be extracted by extractor 110 from audio content information and obtained by obtainer 120. Volume controller 161 obtains volume information obtained by obtainer 120.

Direction controller 162 performs convolution processing on a sound signal on which reduction processing has been performed and a generated reverberation signal, based on space information, position information, and detection information obtained by obtainer 120.

As described above, space information indicates the shape and an acoustic property of a sound reproduction space and the position of a sound source in the sound reproduction space, the position information indicates a reproduction space in which a listener is present and the position of the listener in the reproduction space, and the detection information indicates the direction of the listener and the position of the listener represented by coordinates on the horizontal plane and the value of the height in the vertical direction. Direction controller 162 performs processing on a sound signal and a reverberation signal, with reference to a head related transfer function stored in storage 170.

More specifically, direction controller 162 performs processing for convolving a sound signal with the head related transfer function, to cause a sound indicated by a sound signal from the position of the sound source indicated by the space information to the position of the listener indicated by position information. At this time, direction controller 162 may determine the head related transfer function by taking into consideration the direction of the listener indicated by the detection information, and perform processing for convolving a sound signal with the determined head related transfer function. Direction controller 162 performs processing for convolving a reverberation signal with a head related transfer function, to cause reverberation indicated by a reverberation signal to reach the position at which a listener facing in the direction indicated by detection information is present in a reproduction space.

Direction controller 162 generates a synthesized sound signal resulting from synthesizing the sound signal and the reverberation signal on each of which the processing for convolving with a head related transfer function has been performed, and outputs the generated synthesized sound signal to headphones 200. Note that when direction controller 162 generates a synthesized sound signal, processing is performed to cause a sound indicated by a sound signal and reverberation indicated by a reverberation signal to have the volume of a sound and the volume of reverberation that are determined by volume controller 161, respectively.

Furthermore, second outputter 202 of headphones 200 reproduces, based on the synthesized sound signal output by first outputter 160, a sound with reduced noise and reverberation, the volumes of which are indicated by the synthesized sound signal.

In this manner, obtainer 120, processing determiner 130, reduction processor 140, reverberation generator 150, and first outputter 160 output a synthesized sound signal that can be reproduced by headphones 200, based on information and a signal extracted by extractor 110. Thus, for example, obtainer 120, processing determiner 130, reduction processor 140, reverberation generator 150, and first outputter 160 function as a renderer.

Note that in the present embodiment, acoustic reproduction device 100 includes reverberation generator 150, yet in other examples, acoustic reproduction device 100 may not include reverberation generator 150. In this case, first outputter 160 outputs a sound signal on which reduction processor 140 has performed reduction processing.

Storage 170 is a storage device that stores therein information to be used in information processing performed by each of extractor 110, obtainer 120, processing determiner 130, reduction processor 140, reverberation generator 150, and first outputter 160.

Information stored in storage 170 includes a computer program executed by each of extractor 110, obtainer 120, processing determiner 130, reduction processor 140, reverberation generator 150, and first outputter 160.

### Operation Example 1

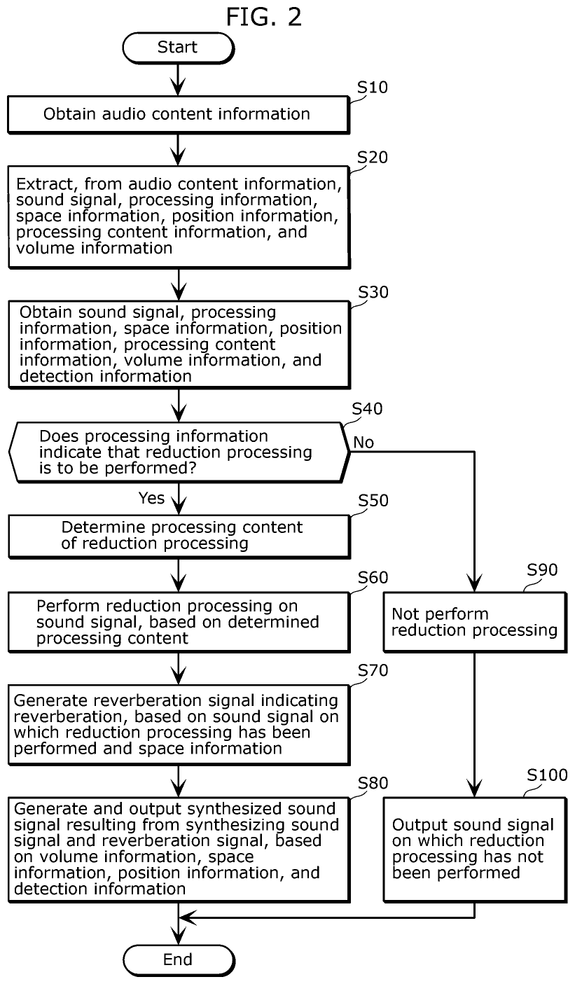

In the following, Operation Example 1 of an acoustic reproduction method executed by acoustic reproduction device 100 is to be described. FIG. 2 is a flowchart illustrating Operation Example 1 of acoustic reproduction device 100 according to the present embodiment.

First, extractor 110 obtains audio content information (S10).

Extractor 110 extracts a sound signal, processing information, space information, position information, processing content information, and volume information from the obtained audio content information (S20).

Obtainer 120 obtains the sound signal, the processing information, the space information, the position information, the processing content information, and the volume information that are extracted by extractor 110 and detection information output by headphones 200 (S30). This step corresponds to an obtaining step.

Processing determiner 130 determines whether the processing information obtained by obtainer 120 indicates that reduction processing is to be performed (S40). For example, processing determiner 130 determines that the processing information indicates the reduction processing is to be performed when “1” is indicated as a flag in the processing information. For example, processing determiner 130 determines that the processing information indicates the reduction processing is not to be performed when “0” is indicated as a flag in the processing information.

Here, when processing determiner 130 determines that the processing information indicates the reduction processing is to be performed (Yes in S40), processing determiner 130 determines processing content of the reduction processing (S50). More specifically, processing determiner 130 determines processing content indicated by the processing content information obtained by obtainer 120 as the processing content of the reduction processing. Step S50 corresponds to a processing determination step.

Subsequently, reduction processor 140 performs reduction processing on the sound signal obtained by obtainer 120, based on the processing content determined by processing determiner 130 (step S60). A sound signal on which reduction processing has been performed is a signal indicating a sound with reduced noise. Step S60 corresponds to a reduction processing step.

Reverberation generator 150 generates a reverberation signal indicating reverberation, based on the sound signal on which reduction processor 140 has performed reduction processing in step S60 and space information obtained by obtainer 120 (S70). The reverberation signal generated by reverberation generator 150 is a signal indicating reverberation based on a sound with reduced noise. Step S70 corresponds to a reverberation generation step.

First outputter 160 outputs, to headphones 200, a synthesized sound signal resulting from synthesizing the sound signal on which reduction processor 140 has performed reduction processing in step S60 and the reverberation signal generated by reverberation generator 150 (S80). Step S80 corresponds to an output step. More specifically, volume controller 161 and direction controller 162 that are included in first outputter 160 generate a synthesized sound signal based on the volume information, the space information, the position information, and the detection information that are obtained by obtainer 120, and outputs the synthesized sound signal to headphones 200.

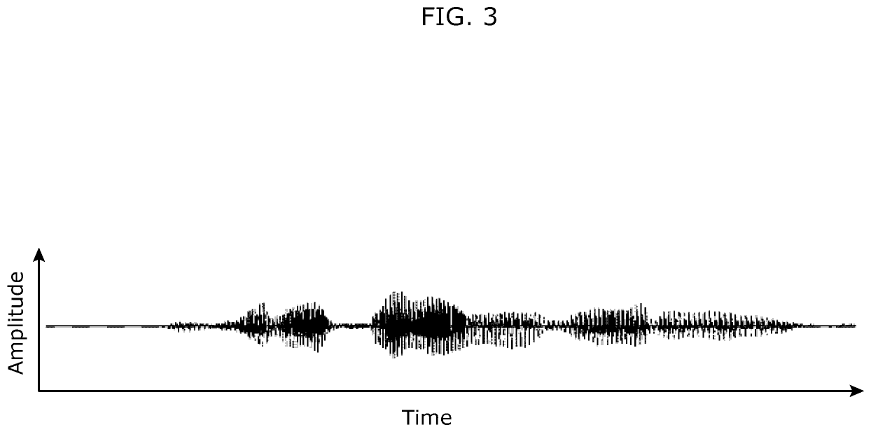

Here, a sound signal on which reduction processing has been performed and a synthesized sound signal are to be described with reference to FIG. 3 to FIG. 6.

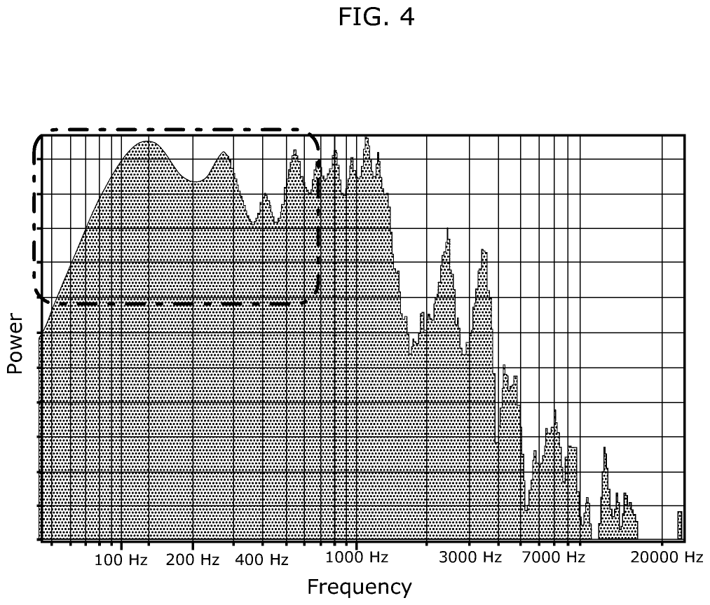

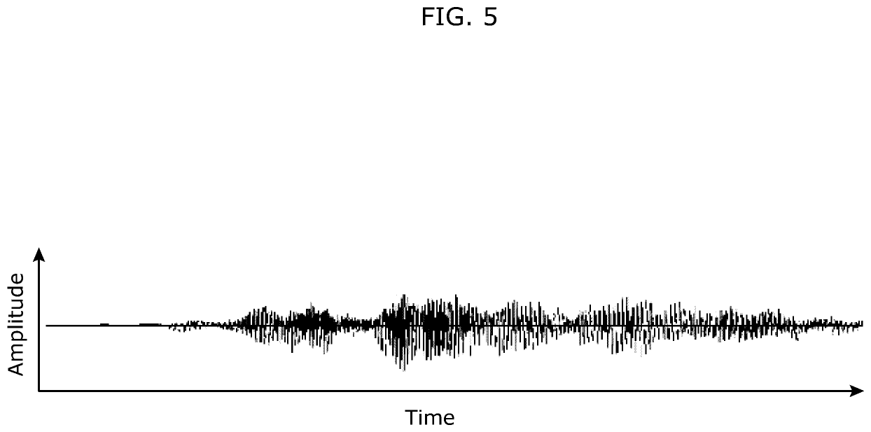

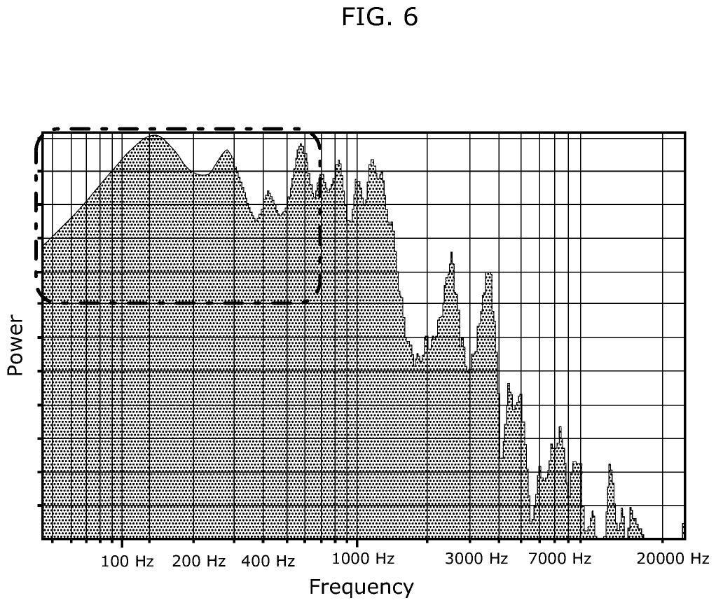

FIG. 3 illustrates a relation between time and amplitude of a sound signal on which reduction processing has been performed according to the present embodiment. FIG. 4 illustrates a power spectrum of the sound signal illustrated in FIG. 3. FIG. 5 illustrates a relation between time and amplitude of a synthesized sound signal according to the present embodiment. FIG. 6 illustrates a power spectrum of the synthesized sound signal illustrated in FIG. 5.

The power spectrum illustrated in FIG. 4 is a spectrum resulting from performing fast Fourier transform processing on the sound signal illustrated in FIG. 3, and the power spectrum illustrated in FIG. 6 is a spectrum resulting from performing fast Fourier transform processing on the synthesized sound signal illustrated in FIG. 5.

The synthesized sound signal illustrated in FIG. 5 and FIG. 6 is a signal resulting from synthesizing the sound signal illustrated in FIG. 3 and FIG. 4 and a reverberation signal generated based on the sound signal. Thus, a signal resulting from deducting the sound signal illustrated in FIG. 3 from the synthesized sound signal illustrated in FIG. 5 corresponds to a reverberation signal.

Here, FIG. 4 and FIG. 6 are to be compared. As shown by the regions surrounded by dash-dot line rectangles in FIG. 4 and FIG. 6, the noise floor level in a region having a frequency of 700 Hz or less is higher in FIG. 6. Thus, the noise floor level of a synthesized sound signal that includes a reverberation signal in that region is higher.

Here, a noise floor level is to be briefly described. A noise floor level represents a level of noise included in a sound signal. A noise floor level is represented by the magnitude of a recessed portion of the spectrum power in FIG. 4 in which irregularities in level are observed. The noise floor level can be calculated in a simplified manner using an average value of the level in recessed portions in a predetermined frequency zone, for example.

In step S80, such a synthesized sound signal is output to headphones 200, and based on the synthesized sound signal output by first outputter 160, second outputter 202 of headphones 200 reproduces a sound with reduced noise and reverberation that are indicated by the synthesized sound signal.

Note that when acoustic reproduction device 100 does not include reverberation generator 150, step S70 is not performed, and first outputter 160 outputs a sound signal on which reduction processor 140 has performed reduction processing.

When processing determiner 130 determines that processing information indicates reduction processing is not to be performed (No in S40), processing determiner 130 does not determine processing content of reduction processing, and reduction processor 140 does not perform reduction processing (S90).

First outputter 160 outputs a sound signal on which reduction processor 140 has not performed reduction processing to headphones 200 (S100).

In this manner, in Operation Example 1, the acoustic reproduction method includes the obtaining step, the processing determination step, the reduction processing step, and the output step. In the obtaining step, a sound signal indicating a sound that reaches a listener in a sound reproduction space, and processing information indicating whether to perform, on the sound signal, reduction processing for reducing noise included in the sound are obtained. In the processing determination step, processing content of the reduction processing is determined when the obtained processing information indicates that reduction processing is to be performed. In the reduction processing step, reduction processing is performed based on the determined processing content. In the output step, a sound signal on which reduction processing has been performed is output.

Accordingly, since processing information is obtained in the obtaining step, noise included in a sound indicated by a sound signal is reduced in the reduction processing step, according to whether to perform noise reduction processing, which is indicated by the processing information. In Operation Example 1, a reverberation signal indicating reverberation may be generated based on the sound signal on which such processing has been performed (step S70), and a synthesized sound signal resulting from synthesizing the sound signal and the reverberation signal (a synthesized sound signal) may be output to a listener. In this case, reverberation that the listener hears is a sound based on a sound with reduced noise. The listener is less likely to feel odd even when he/she hears such reverberation, and thus can hear a sound that provides realistic sensations. Hence, an acoustic reproduction method can be realized with which a sound that provides further realistic sensations can be output in such a case, even when a sound indicated by the obtained sound signal includes noise.

In Operation Example 1, processing content information indicating processing content is obtained in the obtaining step. In the reduction processing step, processing content indicated by the obtained processing content information is performed.

Accordingly, reduction processing can be performed according to the processing content indicated by the processing content information.

In Operation Example 1, extractor 110 extracts, from audio content information, processing information for a sound signal, yet time-series sound signals that are input may be analyzed and processing information may be set. For analysis of time-series sound signals, a technique for estimating the magnitude of noise through observing a time transition of an auto-correlation value or a frequency component, for example, has been known and processing information may be set by determining the estimated magnitude of noise using a predetermined threshold.

Furthermore, time-series sound signals to be input may be sound signals collected by an input device such as a microphone, instead of sound signals extracted by extractor 110 and input in association with audio content information. In this case, audio content information associated with a sound signal may be information set based on an environment in which a sound is collected. Accordingly, noise in a sound collecting environment, which is included in a sound signal, can be reduced and a predetermined virtual space can be reproduced.

In Operation Example 1, the acoustic reproduction method includes a reverberation generation step of generating a reverberation signal indicating reverberation, based on a sound signal on which reduction processing has been performed and obtained space information. In the output step, a synthesized sound signal resulting from synthesizing the sound signal on which reduction processing has been performed and the generated reverberation signal is output.

Accordingly, a reverberation signal indicating reverberation is generated based on a sound signal indicating a sound with reduced noise. Thus, reverberation that the listener hears is a sound based on a sound with reduced noise. The listener is less likely to feel odd even when he/she hears such reverberation, and thus can hear a sound that provides realistic sensations. Hence, an acoustic reproduction method with which a sound that provides further realistic sensations can be output, even when a sound indicated by an obtained sound signal includes noise.

In the present embodiment, a computer program causes a computer to execute the acoustic reproduction method described above.

Accordingly, the computer can execute the above acoustic reproduction method according to the program.

### Operation Example 2

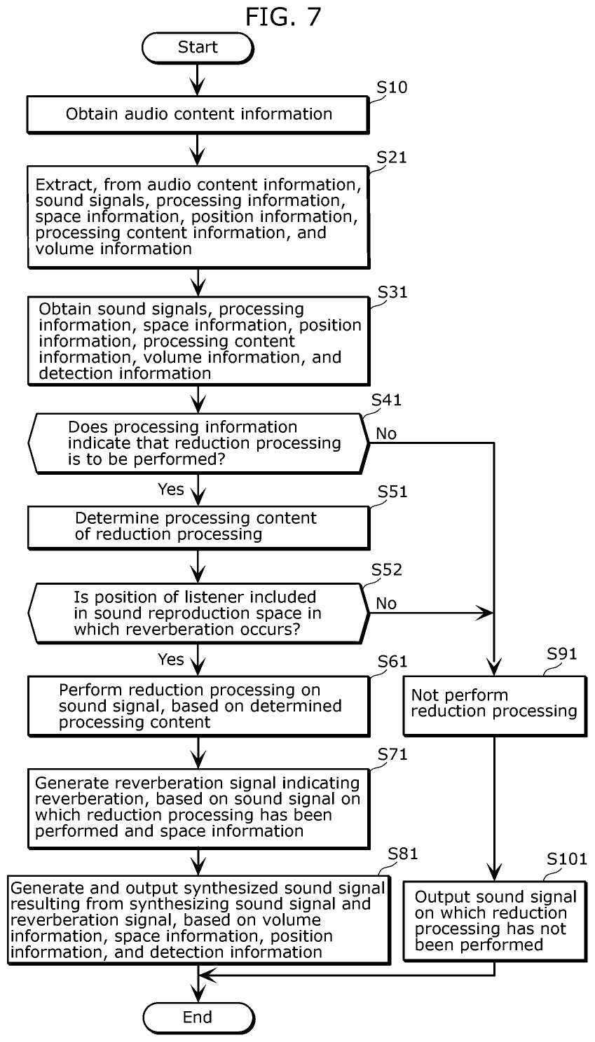

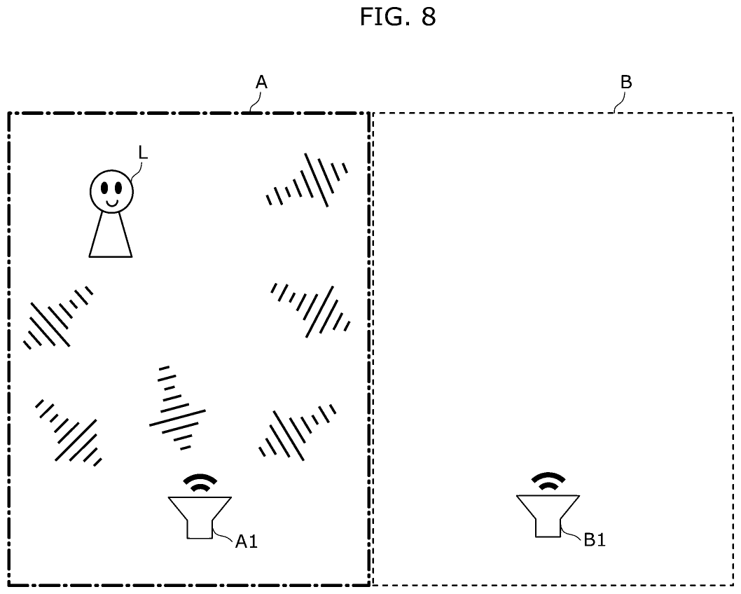

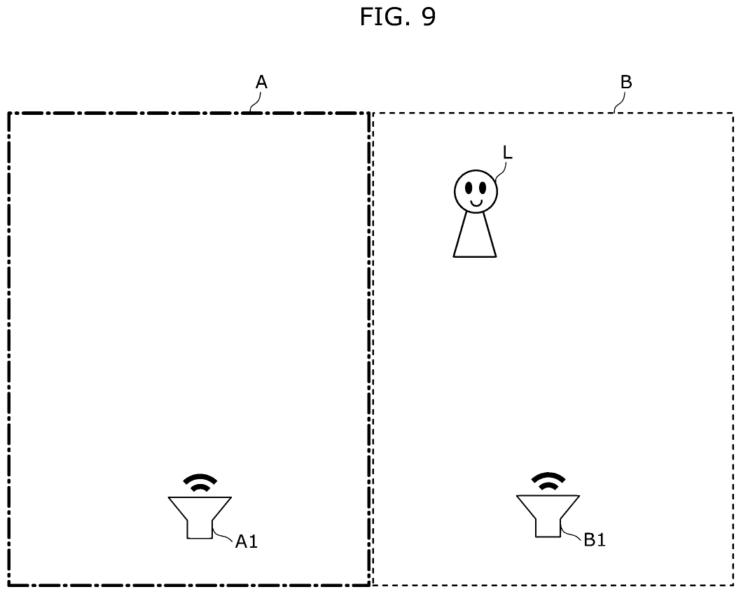

In Operation Example 2, an example in which two sound reproduction spaces are provided and a sound source is provided in each of the two sound reproduction spaces is to be described. FIG. 7 is a flowchart illustrating Operation Example 2 of acoustic reproduction device 100 according to the present embodiment. FIG. 8 and FIG. 9 each illustrate two sound reproduction spaces A and B and the positions of two sound sources A1 and B1 according to the present embodiment.

Two sound reproduction spaces A and B are examples of the above-stated sound reproduction space, and sounds output from two sound sources A1 and B1 are examples of the above-stated sounds that reach listener L. Note that for a distinguishing purpose, a sound output by sound source A1 is a first sound and the first sound includes a target sound for the listener to hear and noise other than the target sound in the following. A first sound signal indicating a first sound is an example of the above-stated sound signal. First processing information indicating whether to perform reduction processing on a first sound signal is an example of the above-stated processing information. First space information on sound reproduction space A is an example of the above-stated space information, and indicates the shape and an acoustic property of sound reproduction space A. A sound output by sound source B1 is a second sound, and the second sound includes a target sound for the listener to hear and noise other than the target sound. A second sound signal indicating a second sound is an example of the above-stated sound signal. Second processing information indicating whether to perform reduction processing on a second sound signal is an example of the above-stated processing information. Second space information on sound reproduction space B is an example of the above-stated space information, and indicates the shape and an acoustic property of sound reproduction space B.

Sound reproduction space A and sound reproduction space B are adjacent to each other. Sound reproduction space A is a space in which reverberation occurs. Thus, first space information that indicates the shape and an acoustic property of sound reproduction space A indicates that sound reproduction space A is a space in which reverberation occurs.

Sound reproduction space B is a space in which reverberation does not occur. Thus, second space information that indicates the shape and an acoustic property of sound reproduction space B indicates that sound reproduction space B is a space in which reverberation does not occur.

First, Operation Example 2 in the case where the position of listener L is in sound reproduction space A as illustrated in FIG. 8 is to be described. In Operation Example 2, position information indicates that a listener is present in sound reproduction space A and indicates the position in sound reproduction space A at which listener L is present.

As illustrated in FIG. 7, first, extractor 110 obtains audio content information (S10).

Extractor 110 extracts sound signals, processing information, space information, position information, processing content information, and volume information from the obtained audio content information (S21). More specifically, extractor 110 extracts, from the audio content information, a first sound signal, a second sound signal, first processing information, second processing information, first space information, second space information, position information, processing content information, and volume information.

Obtainer 120 obtains the sound signals, the items of processing information, the items of space information, the position information, the processing content information, and the volume information that are extracted by extractor 110 and detection information output by headphones 200 (S31). More specifically, obtainer 120 obtains the first sound signal, the second sound signal, the first processing information, the second processing information, the first space information, the second space information, the position information, the processing content information, the volume information, and detection information.

Processing determiner 130 determines whether the items of processing information obtained by obtainer 120 indicate that reduction processing is to be performed (S41). The following processing that includes step S41 is performed separately for a first sound and a second sound.

First, processing for a first sound is to be described.

In step S41, processing determiner 130 determines whether the first processing information obtained by obtainer 120 indicates that reduction processing is to be performed. Here, the first processing information indicates that reduction processing is to be performed.

Thus, processing determiner 130 determines that the first processing information indicates that reduction processing is to be performed (Yes in S41), and determines processing content of the reduction processing (S51). More specifically, processing determiner 130 determines processing content indicated by the processing content information obtained by obtainer 120 as the processing content of the reduction processing.

Furthermore, reduction processor 140 determines whether the position of listener L is included in a sound reproduction space in which reverberation occurs, based on the space information (first space information) obtained by obtainer 120 and the position information obtained by obtainer 120 (S52). Here, the position information indicates that a listener is present in sound reproduction space A. The first space information indicates that sound reproduction space A is a space in which reverberation occurs. Thus, reduction processor 140 determines that the position of listener L is included in sound reproduction space A in which reverberation occurs (Yes in step S52).

In this case, reduction processor 140 performs reduction processing on the sound signal (the first sound signal) obtained by obtainer 120, based on the processing content determined by processing determiner 130 (step S61). The first sound signal on which the reduction processing has been performed is a signal indicating a first sound with reduced noise.

Reverberation generator 150 generates a reverberation signal indicating reverberation, based on the sound signal (the first sound signal) on which reduction processor 140 has performed reduction processing in step S61 and the space information (the first space information) obtained by obtainer 120 (S71). The reverberation signal generated by reverberation generator 150 in step S71 is a signal indicating reverberation based on the first sound with reduced noise.

First outputter 160 outputs, to headphones 200, a synthesized sound signal resulting from synthesizing the sound signal (the first sound signal) on which reduction processor 140 has performed reduction processing in step S61 and the reverberation signal generated by reverberation generator 150 (S81). More specifically, volume controller 161 and direction controller 162 that are included in first outputter 160 generate a synthesized sound signal based on the volume information, the first space information, the position information, and the detection information that are obtained by obtainer 120, and outputs the synthesized sound signal to headphones 200.

Here, returning back to step S41, processing for a second sound is to be described.

In step S41, processing determiner 130 determines whether the second processing information obtained by obtainer 120 indicates that reduction processing is to be performed. Here, the second processing information indicates that reduction processing is not to be performed.

Thus, processing determiner 130 determines that the second processing information indicates reduction processing is not to be performed (No in S41), so processing determiner 130 does not determine processing content of reduction processing, and reduction processor 140 does not perform reduction processing (S91).

First outputter 160 outputs a sound signal (a second sound signal) on which reduction processor 140 has not performed reduction processing to headphones 200 (S101).

From the above, second outputter 202 of headphones 200 performs the following processing in the example in Operation Example 2 illustrated in FIG. 8. Thus, second outputter 202 reproduces the first sound with reduced noise and reverberation indicated by the synthesized sound signal output by first outputter 160, and reproduces a second sound indicated by the second sound signal output by first outputter 160.

Furthermore, in the following, the case where the position of listener L is in sound reproduction space B as illustrated in FIG. 9 in Operation Example 2 is to be described. In Operation Example 2, position information indicates that a listener is present in sound reproduction space B and indicates the position of listener L within sound reproduction space B.

Steps S10 to S31 are performed as described above.

Subsequently, processing determiner 130 determines whether the processing information obtained by obtainer 120 indicates that reduction processing is to be performed (S41). Also when the position of listener L is in sound reproduction space B, the following processing that includes step S41 is performed separately for a first sound and a second sound.

First, processing for a first sound is to be described.

In step S41, processing determiner 130 determines whether the first processing information obtained by obtainer 120 indicates that reduction processing is to be performed. Here, the first processing information indicates that reduction processing is to be performed.

Thus, processing determiner 130 determines that the first processing information indicates the reduction processing is to be performed (Yes in S41), and determines processing content of the reduction processing (S51). More specifically, processing determiner 130 determines processing content indicated by the processing content information obtained by obtainer 120 to be processing content of the reduction processing.

Furthermore, reduction processor 140 determines whether the position of listener L is included in a sound reproduction space in which reverberation occurs, based on the space information (second space information) obtained by obtainer 120 and the position information obtained by obtainer 120 (S52). Here, the position information indicates that a listener is present in sound reproduction space B. The second space information indicates that sound reproduction space is a space in which reverberation does not occur.

Thus, reduction processor 140 determines that the position of listener L is included in sound reproduction space B in which reverberation does not occur (No in step S52).

In this case, processing determiner 130 does not determine processing content of reduction processing, and reduction processor 140 does not perform reduction processing (S91). Step S91 is to be described in more detail as below. In the example illustrated in FIG. 9, listener L is in sound reproduction space B in which reverberation does not occur, and thus reverberation generator 150 does not generate a reverberation signal based on a sound signal (a first sound signal) indicating a sound (a first sound) that includes noise. Thus, even when reduction processor 140 does not perform reduction processing, the listener does not hear reverberation based on the sound that includes noise. Thus, more accurately, reduction processor 140 does not need to perform reduction processing, and thus does not perform reduction processing. As a result, the reduction processing is not performed, and thus a processing load of the acoustic reproduction method can be reduced.

Furthermore, first outputter 160 outputs a sound signal (a first sound signal) on which reduction processor 140 has not performed reduction processing to headphones 200 (S101).

Here, returning back to step S41, processing for a second sound is to be described.

In step S41, processing determiner 130 determines whether the second processing information obtained by obtainer 120 indicates that reduction processing is to be performed. Here, the second processing information indicates that reduction processing is not to be performed.

Thus, processing determiner 130 determines that the second processing information indicates reduction processing is not to be performed (No in S41), so processing determiner 130 does not determine processing content of reduction processing, and reduction processor 140 does not perform reduction processing (S91).

First outputter 160 outputs a sound signal (a second sound signal) on which reduction processor 140 has not performed reduction processing to headphones 200 (S101).

Thus, in Operation Example 2, second outputter 202 of headphones 200 reproduces, based on the synthesized sound signal output by first outputter 160, the first sound with reduced noise and reverberation indicated by the synthesized sound signal, and reproduces a second sound indicated by the second sound signal output by first outputter 160.

From the above, second outputter 202 of headphones 200 performs the following processing in the example in Operation Example 2 illustrated in FIG. 9. Thus, second outputter 202 reproduces a first sound indicated by a first sound signal on which reduction processing is not performed and which is output by first outputter 160, and reproduces a second sound indicated by a second sound signal on which reduction processing is not performed and which is output by first outputter 160.

In this manner, in Operation Example 2, in the reduction processing step, when the position of listener L is included in the sound reproduction space in which reverberation does not occur (sound reproduction space B, for example), reduction processing is determined not to be performed.

Accordingly, when the position of listener L is not included in a sound reproduction space (sound reproduction space B, for example) in which reverberation does not occur, reduction processing is not performed, and thus a processing load of the acoustic reproduction method can be reduced.

In Operation Example 2, in the obtaining step, processing content information indicating processing content is obtained, and in the reduction processing step, the processing content indicated by the obtained processing content information is performed.

Accordingly, reduction processing can be performed according to the processing content indicated by the processing content information.

### Embodiment 2

In Embodiment 2, an example in which comparer 180 is provided is to be described.

### [Configuration]

A configuration of acoustic reproduction device 100a according to Embodiment 2 is to be described.

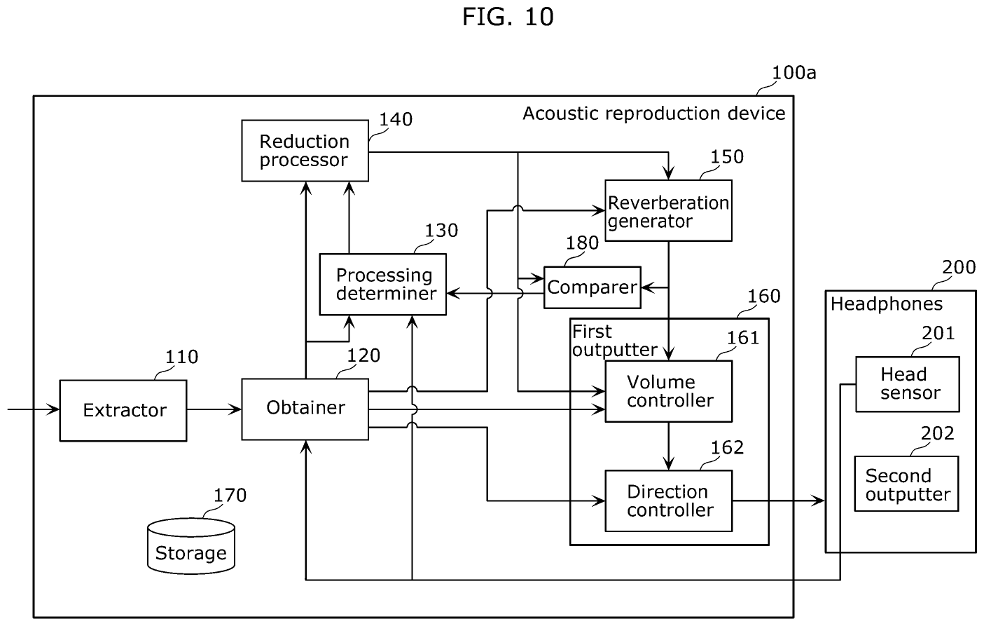

FIG. 10 is a block diagram illustrating a functional configuration of acoustic reproduction device 100a according to the present embodiment.

Acoustic reproduction device 100a according to the present embodiment has the same configuration as that of acoustic reproduction device 100, mainly except that comparer 180 is included.

Thus, acoustic reproduction device 100a includes extractor 110, obtainer 120, processing determiner 130, reduction processor 140, reverberation generator 150, first outputter 160, storage 170, and comparer 180.

In the present embodiment, obtainer 120 obtains threshold data indicating a threshold. The threshold indicated by threshold data is a value used by comparer 180, and details are to be described later.

For example, threshold data is stored in storage 170, and obtainer 120 obtains threshold data stored in storage 170. For example, threshold data may be data extracted by extractor 110 from audio content information, and obtainer 120 may obtain threshold data extracted by extractor 110.

Subsequently, processing performed by comparer 180 is to be described. In the present embodiment, processing in steps S10, S20, S30, S40, S50, S60, and S70 in Operation Example 1 of Embodiment 1 illustrated in FIG. 2 is performed, and thereafter comparer 180 generates a synthesized sound signal.

Comparer 180 generates a synthesized sound signal by performing similar processing to the processing performed by first outputter 160 illustrated in Embodiment 1. Thus, comparer 180 can generate a synthesized sound signal by performing similar processing to the processing performed by volume controller 161 and direction controller 162 that are included in first outputter 160.

Comparer 180 compares a noise floor level in a predetermined frequency range in a power spectrum representing the generated synthesized sound signal with a threshold indicated by the obtained threshold data. Comparer 180 compares a noise floor level in a predetermined frequency range in a power spectrum (the power spectrum illustrated in FIG. 6, for example) indicating the generated synthesized sound signal with a threshold indicated by the threshold data, and outputs the comparison result to processing determiner 130.

Processing determiner 130 updates (determines again) processing content of reduction processing, based on the comparison result output by comparer 180. More specifically, processing determiner 130 updates (determines again) processing content of reduction processing, based on processing content indicated by processing content information obtained by obtainer 120 and the output comparison result.

Accordingly, in the present embodiment, processing determiner 130 determines the processing content once in step S50, and after that, comparer 180 further outputs the comparison result, and processing determiner 130 determines again processing content of reduction processing, based on the comparison result. Thus, processing content once determined in step S50 is updated to the processing content determined based on the comparison result. As compared to the processing content once determined in step S50, the processing content determined based on the comparison result is processing content that causes reduction processing to be processing for reducing noise to a greater extent, as an example.

A threshold indicated by threshold data may be a target value of the above noise floor level. A threshold may be one value. In the present embodiment, a threshold is a value of at least a lower limit and at most an upper limit (or stated differently, a value having a predetermined width).

Processing determiner 130 updates processing content to cause reduction processing to be processing for reducing noise to a greater extent when the noise floor level is higher than the threshold. When the noise floor level is higher than the threshold is the case where noise is insufficiently reduced. When reverberation occurs based on a sound with noise that is insufficiently reduced and listener L hears such reverberation, listener L feels odd so that listener L cannot hear a sound that provides sufficient realistic sensations.

When the noise floor level is higher than the threshold, by processing determiner 130 updating processing content to cause reduction processing to be processing for reducing noise to a greater extent, a reverberation signal generated by reverberation generator 150 can be caused to be a signal indicating reverberation, based on a sound with noise reduced to a greater extent. Furthermore, first outputter 160 outputs, to headphones 200, a synthesized sound signal resulting from synthesizing a sound signal on which reduction processing for reducing noise to a greater extent has been performed and the reverberation signal.

Accordingly, reverberation that listener L hears is a sound based on a sound with noise reduced to a greater extent. Listener L is less likely to feel odd even when he/she hears such reverberation, and thus can hear a sound that provides realistic sensations. Thus, an acoustic reproduction method can be realized with which a sound that provides further realistic sensations can be output in such a case, even when a sound indicated by the obtained sound signal includes noise.

### Operation Example 3

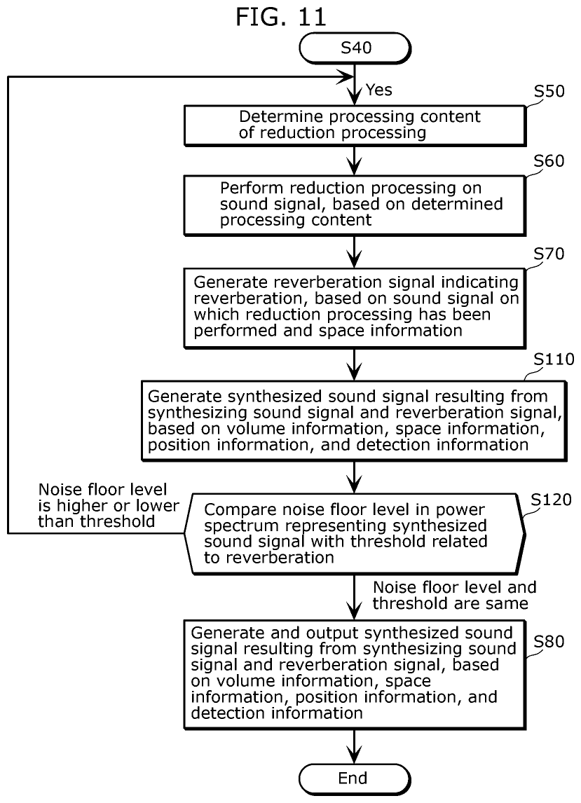

In the following, Operation Example 3 of an acoustic reproduction method executed by acoustic reproduction device 100a is to be described. FIG. 11 is a flowchart illustrating Operation Example 3 of acoustic reproduction device 100a according to the present embodiment.

Also in Operation Example 3, processing of steps S10 to S40 shown in Operation Example 1 in Embodiment 1 is performed. In Operation Example 3, obtainer 120 obtains threshold data in step S10. In Operation Example 3, the case where the result of step S40 is Yes is to be described.

When the result of step S40 is Yes, processing determiner 130 determines processing content once in step S50. Furthermore, processing in steps S60 and S70 is performed.

Next, comparer 180 generates a synthesized sound signal, based on volume information, space information, position information, and detection information that are obtained by obtainer 120 (S110). Comparer 180 generates a synthesized sound signal by performing similar processing to the processing performed by first outputter 160 illustrated in Embodiment 1.

Furthermore, comparer 180 compares a noise floor level in a predetermined frequency range in a power spectrum representing the generated synthesized sound signal with a threshold indicated by the threshold data (S120).

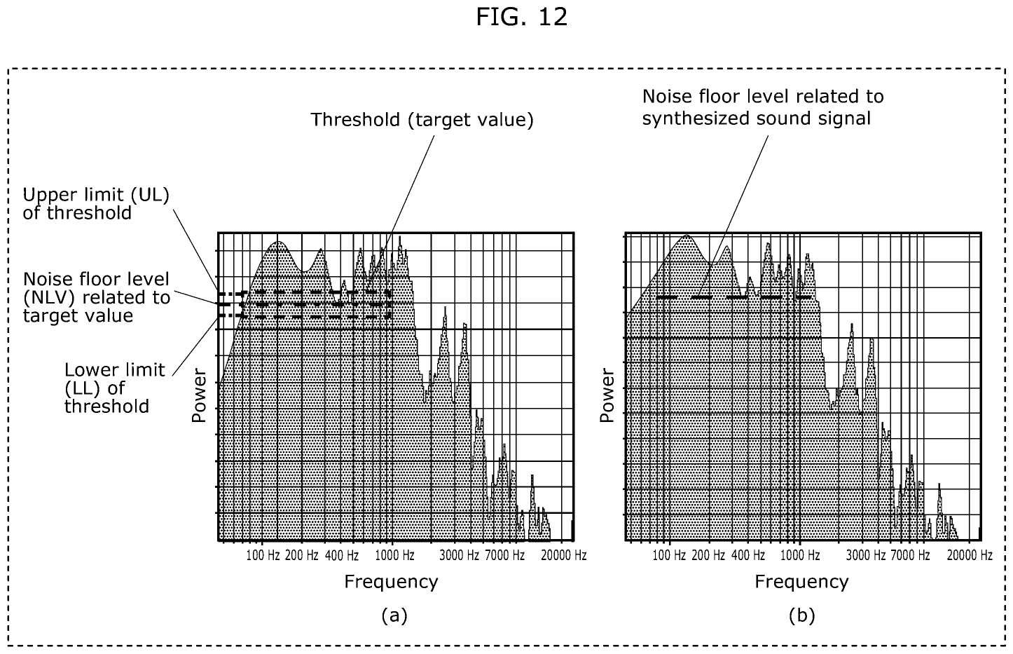

Here, a threshold and a noise floor level are to be described with reference to FIG. 12.

FIG. 12 illustrates a threshold and a noise floor level according to the present embodiment. Part (a) of FIG. 12 illustrates a power spectrum representing a synthesized sound signal that is a target and a threshold. Part (b) of FIG. 12 illustrates a power spectrum representing a synthesized sound signal generated by comparer 180 and a noise floor level in a predetermined frequency range in the power spectrum. Note that in the following, to simplify the description, the noise floor level illustrated in (a) of FIG. 12 may be stated as a noise floor level according to a target value, and the noise floor level shown by (b) of FIG. 12 may be stated as a noise floor level according to a synthesized sound signal.

The power spectrum shown by (a) of FIG. 12 is a target power spectrum of a power spectrum representing a synthesized sound signal generated by comparer 180. A threshold is a target value of a noise floor level as described above. A threshold is a value that includes a noise floor level (a noise floor level according to a target value) in a predetermined frequency range in a power spectrum illustrated in (a) of FIG. 12 as an example. When the upper limit of the threshold illustrated in (a) of FIG. 12 is UL, the lower limit of the threshold illustrated in (a) of FIG. 12 is LL, and the noise floor level according to a target value illustrated in (a) of FIG. 12 is NLV, UL satisfies Expression 1 and LL satisfies Expression 2.

$$U L = N L V \times 1.1 \qquad ( Expression 1 )$$

$$LL = N L V \times 0.9 \qquad ( Expression 2 )$$

Thus, the upper limit (UL) of the threshold and the lower limit (LL) of the threshold are plus and minus 10% of the noise floor level (NLV) according to the target value but are not limited to these, and may be plus and minus 5%, 20%, or 30% of the noise floor level according to the target value.

Note that a predetermined frequency range in the power spectrum illustrated in (a) of FIG. 12 and a predetermined frequency range in the power spectrum illustrated in (b) of FIG. 12 are the same and are at least 100 Hz and at most 700 Hz, for example. Note that the predetermined frequency ranges in the power spectra illustrated in (a) and (b) of FIG. 12 are not limited to at least 100 Hz and at most 700 Hz, and may be other frequency ranges.

In step S120, comparer 180 compares a noise floor level according to a synthesized sound signal with the threshold.

Comparer 180 determines that the noise floor level according to the synthesized sound signal and the threshold are the same when the noise floor level according to the synthesized sound signal is at least the lower limit of the threshold and at most the upper limit of the threshold.

Comparer 180 determines that the noise floor level according to the synthesized sound signal is lower than the threshold when the noise floor level according to the synthesized sound signal is lower than the lower limit of the threshold.

Comparer 180 determines that the noise floor level according to the synthesized sound signal is higher than the threshold when the noise floor level according to the synthesized sound signal is higher than the threshold.

When the noise floor level according to the synthesized sound signal is higher or lower than the threshold, comparer 180 outputs the comparison result to processing determiner 130. In this case, the processing in step S50 is performed again, or specifically, processing determiner 130 updates (determines again) the processing content of reduction processing.

For example, processing content is determined again to cause reduction processing to be processing for reducing noise to a greater extent when the noise floor level according to the synthesized sound signal is higher than the threshold. For example, processing content is determined again to cause reduction processing to be processing for reducing noise to a lesser extent when the noise floor level according to the synthesized sound signal is lower than the threshold.

Subsequently, the processing in step S60 is performed again, or specifically, reduction processor 140 performs reduction processing on the sound signal obtained by obtainer 120, based on the processing content determined again by processing determiner 130. The reduction processing is for reducing noise to a lesser extent.

Furthermore, the processing in step S70 is performed again, or specifically, reverberation generator 150 generates a reverberation signal indicating reverberation, based on a sound signal on which reduction processor 140 has performed the reduction processing in step S60 and space information obtained by obtainer 120. The reverberation signal indicates reverberation based on a sound with noise reduced to a greater extent.

Furthermore, processing in steps S110 and S120 is performed.

In this manner, when the noise floor level according to the synthesized sound signal is higher or lower than the threshold, the processing in steps S50 to S70, S110, and S120 is performed again.

When the noise floor level according to the synthesized sound signal is the same, comparer 180 outputs the result of the comparison to first outputter 160. In this case, the processing in step S80 is performed.

In step S80, for example, first outputter 160 outputs, to headphones 200, a synthesized sound signal resulting from synthesizing a sound signal on which reduction processing for reducing noise to a greater extent has been performed and a reverberation signal indicating reverberation based on the sound with noise reduced to a greater extent. Accordingly, reverberation that listener L hears is a sound based on a sound with noise reduced to a greater extent. Listener L is less likely to feel odd even when he/she hears such reverberation, and can hear a sound that provides realistic sensations. Thus, an acoustic reproduction method can be realized with which a sound that provides further realistic sensations can be output in such a case, even when a sound indicated by the obtained sound signal includes noise.

In this manner, in Operation Example 3, in the obtaining step, threshold data indicating a threshold is obtained. The acoustic reproduction method includes a comparison step of comparing a noise floor level in a predetermined frequency range in a power spectrum representing the synthesized sound signal with a threshold indicated by the obtained threshold data. In the processing determination step, processing content of the reduction processing is updated based on the comparison result in the comparison step.

In this manner, the processing content of the reduction processing is updated based the result of the comparison between the threshold and the noise floor level, and thus a sound that provides more realistic sensations can be output with the acoustic reproduction method.

In Operation Example 3, the threshold is a target value of the noise floor level. In the processing determination step, processing content is updated to cause reduction processing to be processing for reducing noise to a greater extent when the noise floor level is higher than the threshold.

Accordingly, when the noise floor level is higher than the threshold, noise can be reduced to a greater extent, and thus a sound that provides further realistic sensations can be output with the acoustic reproduction method.

### OTHER EMBODIMENTS

The above has described, based on embodiments, the acoustic reproduction method and the acoustic reproduction device according to aspects of the present disclosure, yet the present disclosure is not limited to such embodiments. For example, other embodiments that result from combining elements stated in this Specification and that are acquired by excluding some of the elements can be included as embodiments of the present disclosure. The present disclosure also encompasses variations that result from applying, to the embodiments, various modifications that may be conceived by those skilled in the art without departing from the gist of the present disclosure, that is, within a range that does not depart from the meaning of wording of the claims.

The embodiments shown below may be included in the scope of the one or more aspects of the present disclosure.

(1) One or more of the elements included in the acoustic reproduction device may be a computer system that includes a microprocessor, a ROM, a random access memory (RAM), a hard disk unit, a display unit, a keyboard, and a mouse, for instance. A computer program is stored in the RAM or the hard disk unit. The microprocessor achieves its functionality by operating in accordance with the computer program. Here, the computer program includes a combination of instruction codes indicating instructions to a computer in order to achieve predetermined functionality.

(2) One or more of the elements included in the acoustic reproduction device and the acoustic reproduction method described above may include a single system large scale integration (LSI: large scale integrated circuit). The system LSI is a super multi-function LSI manufactured by integrating multiple components in one chip, and is specifically a computer system configured so as to include a microprocessor, a ROM, a RAM, and others. A computer program is stored in the RAM. The system LSI achieves its functionality by the microprocessor operating in accordance with the computer program.

(3) One or more of elements included in the acoustic reproduction device described above may include an IC card or a single module which can be attached to or detached from the device. The IC card or the module is a computer system that includes a microprocessor, a ROM, and a RAM, for instance. The IC card or the module may be included in the above super multi-function LSI. The IC card or the module achieves its functionality by the microprocessor operating in accordance with the computer program. This IC card or module may have tamper resistant properties.

(4) One or more of the elements included in the acoustic reproduction device may be achieved by a computer program or a digital signal stored in a computer-readable recording medium such as, for example, a flexible disk, a hard disk, CD-ROM, a magneto-optical disc (MO), a digital versatile disc (DVD), DVD-ROM, DVD-RAM, a Blu-ray (registered trademark) disc (BD), or a semiconductor memory. Alternatively, one or more of the elements may be achieved by a digital signal stored in such a recording medium.

One or more of the elements included in the acoustic reproduction device may be achieved by transferring the computer program or the digital signal through an electrical communication line, a wireless or wired communication line, a network typified by the Internet, or data broadcasting, for instance.

(5) The present disclosure may be a method described above. The present disclosure may be a computer program that achieves such method using a computer or a digital signal that includes the computer program.

(6) The present disclosure may be a computer system that includes a microprocessor and a memory, the memory may store therein the computer program, and the microprocessor may operate in accordance with the computer program.

(7) The present disclosure may be achieved by another independent computer system by recording the program or the digital signal in the recording medium and transferring the recording medium or by transferring the program or the digital signal via the network, for instance.

(8) The above embodiments and the variations may be combined.

A video in conjunction with a sound output by headphones 200 may be presented to listener L. In this case, although not illustrated in, for instance, FIG. 1, a display device such as a liquid crystal panel or an organic electroluminescent (EL) panel may be provided in the vicinity of listener L, for example, and the video is presented on the display device. The video may be presented by listener L wearing a head-mount display, for instance.

Note that audio content information in the present disclosure can be reworded as a bit stream that includes a sound signal (sound information) and metadata. In the audio content information according to the present disclosure, processing information, space information, position information, and processing content information can be considered as information included in the metadata in the bit stream. For example, acoustic reproduction device 100 may obtain audio content information as a bit stream encoded in a predetermined format such as MPEG-H 3D Audio (ISO/IEC 23008-3). As an example, an encoded sound signal includes information on a target sound that is reproduced by acoustic reproduction device 100. A target sound herein is a sound emitted by a sound source object present in a sound reproduction space or a natural environment sound, and may include a mechanical sound or a sound from an animal including a person, for example. Note that when a plurality of sound source objects are present in a sound reproduction space, acoustic reproduction device 100 obtains a plurality of sound signals corresponding to the plurality of sound source objects.

Metadata is information for use in controlling, for example, acoustic processing on sound information in acoustic reproduction device 100. Metadata may be information for use in describing a scene expressed in a virtual space (a sound reproduction space). A scene herein is a terminology that indicates an aggregate of all elements that express a three-dimensional video and an acoustic event in a virtual space, which is modeled by acoustic reproduction device 100 using metadata. Thus, metadata herein may include not only information for controlling acoustic processing, but also information for controlling video processing. Of course, the metadata may include information for controlling only acoustic processing or video processing, or may include information for use in controlling both.

Acoustic reproduction device 100 generates virtual acoustic effects by preforming acoustic processing on sound information, with use of, for instance, metadata included in a bit stream and interactive position information of listener L additionally obtained. In the present embodiment, out of the acoustic effects, generation of a late reverberation sound is mainly described, yet other acoustic processing may be performed with use of metadata. For example, it is conceivable to add at least one of acoustic effects such as diffracted sound generation, a range attenuation effect, localization, sound image localization processing, and the Doppler effect. In addition, information for switching between on and off of all or one or more of the acoustic effects may be added as metadata.

Note that entire metadata or part of metadata may be obtained from where other than a bit stream that includes sound information. For example, metadata for controlling an acoustic sound or metadata for controlling a video may be obtained from where other than from a bit stream or both may be obtained from where other than from a bit stream.

When metadata for controlling a video is included in a bit stream obtained by acoustic reproduction device 100, acoustic reproduction device 100 may have a function of outputting metadata that can be used for controlling a video to a display device that displays images or to a stereoscopic video reproduction device that reproduces stereoscopic videos.

As an example, encoded metadata includes information on a sound reproduction space that includes a sound source object that emits a sound and an obstacle object, and information on a localization position when a sound image of the sound is localized at a predetermined position in a sound reproduction space (or stated differently, a sound is perceived as a sound that has reached from a predetermined direction), that is, information on the predetermined direction. Here, an obstacle object is an object that can influence a sound emitted by a sound source object and perceived by listener L, by, for example, blocking or reflecting the sound between the sound source object and listener L. An obstacle object can include an animal such as a person or a movable body such as a machine, in addition to a stationary object. When a plurality of sound source objects are present in a sound reproduction space, another sound source object may be an obstacle object for a certain sound source object. Non-emitting sound source objects such as building material and inanimate objects and sound emitting sound source objects can both be obstacle objects.

As space information included in metadata, information indicating not only the shape of a sound reproduction space, but also the shape and the position of an obstacle object present in the sound reproduction space and the shape and the position of a sound source object present in the sound reproduction space may be included. A sound reproduction space may be a closed space or an open space, and metadata includes information that indicates a reflectance of a structure that can reflect a sound in the sound reproduction space such as a floor, a wall, or a ceiling, for example, and a reflectance of an obstacle object present in the sound reproduction space. Here, a reflectance is an energy ratio between a reflected sound and an incident sound, and is set for each sound frequency band. Of course, a reflectance may be uniformly set, irrespective of a sound frequency band. When the sound reproduction space is an open space, for example, a uniformly set parameter such as an attenuation factor, a diffracted sound, or an initial reflected sound may be used.

In the above description, a reflectance is stated as a parameter with regard to an obstacle object or a sound source object included in metadata, yet the metadata may include information other than a reflectance. For example, information on the material of an object may be included as metadata related to both of a sound source object and a non-emitting sound source object. Specifically, metadata may include a parameter such as a diffusion factor, a transmittance, or an acoustic absorptivity.

As information on a sound source object, information for designating the volume, a radiation property (directivity), a reproduction condition, the number and types of sound sources emitted by one object, or a sound source region of an object may be included. The reproduction condition may determine that a sound is, for example, a sound that is continuously being emitted or is emitted at an event. A sound source region of an object may be determined based on a relative relation between the position of listener L and a position of the object or may be determined based on the object as a reference. When the sound source region is determined based on a relative position between the position of listener L and the position of the object, listener L can be made to perceive based on, as a reference, the plane through which listener L is viewing the object, as if sound X were produced from the right of the object and sound Y were produced from the left of the object when viewed from listener L. When the sound source region is determined based on the object as a reference, which sound is emitted from which region of the object can be fixed, irrespective of the direction in which listener L is viewing. For example, listener L can be made to perceive as if a high sound were being emitted from the right side and a low sound were being emitted from the left side when the object is viewed from the front. In this case, when listener L moves around to the back side of the object, listener L can be made to perceive as if a low sound were being emitted from the right side and a high sound were being emitted from the left side when the object is viewed from the back side.

As metadata with regard to a space, a time until when an initial reflected sound reaches, a reverberation time, or a ratio between a direct sound and a diffused sound, for instance, can be included. When the ratio between a direct sound and a diffused sound is zero, listener L can be caused to perceive only a direct sound.

Although a description has been given that information indicating the position and the direction of listener L is included in a bit stream as metadata, the bit stream may not include information indicating the position and the direction of listener L that interactively change. In this case, the information indicating the position and the direction of listener L may be obtained from information other than the bit stream. For example, position information of listener L in a VR space may be obtained from an application that provides VR content, whereas for position information of listener L for presenting a sound as AR, position information obtained by performing self-position estimation by a mobile terminal using the global positioning system (GPS), a camera, or laser imaging detection and ranging (LiDAR), for instance, may be used. Note that sound information and metadata may be stored in a single bit stream or may be separately stored in plural bit streams. Similarly, sound information and metadata may be stored in a single file or may be separately stored in plural files.

When sound information and metadata are separately stored in plural bit streams, information indicating a related other bit stream may be included in one or more of the plural bit streams in which the sound information and the metadata are stored.

Furthermore, the information indicating the related other bit stream may be included in the metadata or control information of each of the plural bit streams in which the sound information and the metadata are stored. When the sound information and the metadata are separately stored in plural files, information indicating a related other bit stream or a related other file may be included in one or more of the plural files in which the sound information and the metadata are stored. Furthermore, the information indicating the related other bit stream or the related other file may be included in the metadata or the control information of each of the plural bit streams in which the sound information and the metadata are stored.

Here, the related bit stream or the related file are a bit stream and a file, respectively, that may be simultaneously used in acoustic processing, for example. Furthermore, the information indicating the related other bit stream may be described together with the metadata or the control information of one of the plural bit streams in which the sound information and the metadata are stored or may be divided and described in the metadata or the control information included in two or more bit streams among the plural bit streams in which the sound information and the metadata are stored. Similarly, the information indicating the related other bit stream or the related other file may be described together with the metadata or the control information in one of the plural files in which the sound information and the metadata are stored, or may be divided and described in the metadata or the control information included in two or more files among the plural files in which the sound information and the metadata are stored. Furthermore, a control file described together with the information indicating the related other bit stream or the related other file may be separately generated from the plural files in which the sound information and the metadata are stored. At this time, the control file may not store therein sound information or metadata.

Here, information indicating a related other bit stream or a related other file may be an identifier indicating the other bit stream, a file name showing the other file, a uniform resource locator (URL), or a uniform resource identifier (URI), for instance. In this case, obtainer 120 identifies or obtains a bit stream or a file, based on information indicating a related other bit stream or a related other file. Information indicating a related other bit stream may be included in the metadata or the control information of at least one of plural bit streams in which the sound information and the metadata are stored, and furthermore information indicating a related other file may be included in the metadata or the control information of at least one of plural files in which the sound information and the metadata are stored. Here, a file that includes information indicating a related bit stream or a related file may be a control file such as a manifest file for use in distributing content, for example.

Extractor 110 decodes encoded metadata, and provides obtainer 120 with the decoded metadata. Obtainer 120 provides each of processing determiner 130, reduction processor 140, reverberation generator 150, and first outputter 160 with the obtained metadata. Here, rather than providing each of the processing elements such as processing determiner 130, reduction processor 140, reverberation generator 150, and first outputter 160 with the same metadata, obtainer 120 may provide each of the processing elements with metadata to be used by the processing element.

Obtainer 120 further obtains detection information that includes a rotation amount or a displacement amount detected by head sensor 201 and the position and the direction of listener L. Obtainer 120 determines the position and the direction of listener L in a sound reproduction space, based on the obtained detection information. More specifically, obtainer 120 determines the position and the direction of listener L indicated by the obtained detection information to be the position and the direction of listener L in the sound reproduction space. Obtainer 120 updates position information included in metadata according to the position and the direction of listener L that are determined. Thus, the metadata with which obtainer 120 provides each of the processing elements is metadata that includes updated position information.

In the present embodiment, acoustic reproduction device 100 has a function as a renderer that generates a sound signal added with acoustic effects, but the entire or part of the function as the renderer may be performed by a server. Thus, all or one or more of extractor 110, obtainer 120, processing determiner 130, reduction processor 140, reverberation generator 150, and first outputter 160 may be in a server not illustrated. In this case, a sound signal generated in the server or a sound signal resulting from synthesis in the server is received by acoustic reproduction device 100 through a communication module not illustrated and reproduced by headphones 200.

### INDUSTRIAL APPLICABILITY

The present disclosure can be used in an acoustic reproduction method and an acoustic reproduction device, and is applicable in particular to a stereophonic sound reproduction system, for instance.

1. An acoustic reproduction method comprising:
obtaining a sound signal and processing information, the sound signal indicating a sound that reaches a listener in a sound reproduction space, the processing information indicating whether to perform, on the sound signal, reduction processing for reducing noise included in the sound;
determining processing content of the reduction processing when the processing information obtained indicates that the reduction processing is to be performed;
performing the reduction processing, based on the processing content determined; and
outputting the sound signal on which the reduction processing has been performed.

2. The acoustic reproduction method according to claim 1,
wherein in the obtaining, space information and position information are obtained, the space information indicating a shape and an acoustic property of the sound reproduction space, the position information indicating a position of the listener in the sound reproduction space, and
in the performing, whether to perform the reduction processing is determined based on the space information obtained and the position information obtained.

3. The acoustic reproduction method according to claim 2,
wherein in the performing, the reduction processing is determined not to be performed when the position of the listener is included in the sound reproduction space in which no reverberation occurs.

4. The acoustic reproduction method according to claim 1,
wherein in the obtaining, processing content information indicating the processing content is obtained, and
in the performing, the processing content indicated by the processing content information obtained is performed.

5. The acoustic reproduction method according to claim 2, further comprising:
generating a reverberation signal indicating reverberation, based on the sound signal on which the reduction processing has been performed and the space information obtained,
wherein in the outputting, a synthesized sound signal is output, the synthesized sound signal resulting from synthesizing the sound signal on which the reduction processing has been performed and the reverberation signal generated.

6. The acoustic reproduction method according to claim 5,
wherein in the obtaining, threshold data indicating a threshold is obtained,
the acoustic reproduction method further comprises:
comparing a noise floor level with the threshold indicated by the threshold data obtained, the noise floor level being in a predetermined frequency range in a power spectrum representing the synthesized sound signal, and
in the determining, the processing content of the reduction processing is updated based on a comparison result obtained in the comparing.

7. The acoustic reproduction method according to claim 6,
wherein the threshold is a target value of the noise floor level, and
in the determining, the processing content is updated to cause the reduction processing to be processing for reducing the noise to a greater extent when the noise floor level is higher than the threshold.

8. A non-transitory computer-readable recording medium having recorded thereon a computer program for causing a computer to execute the acoustic reproduction method according to claim 1.

9. An acoustic reproduction device comprising:
an obtainer that obtains a sound signal and processing information, the sound signal indicating a sound that reaches a listener in a sound reproduction space, the processing information indicating whether to perform, on the sound signal, reduction processing for reducing noise included in the sound;
a processing determiner that determines processing content of the reduction processing when the processing information obtained indicates that the reduction processing is to be performed;
a reduction processor that performs the reduction processing, based on the processing content determined; and
an outputter that outputs the sound signal on which the reduction processing has been performed.
